(19) United States
(12) Patent Application Publication
(10) Pub. No.: US 2018/0150748 A1
(43) Pub. Date: May 31, 2018

(54) Enhanced Ingestion of Question-Answer Pairs into Question Answering Systems by Preprocessing Online Discussion Sites

(71) Applicant: International Business Machines Corporation, Armonk, NY (US)

(72) Inventors: Paul R. Bastide, Boxford, MA (US); Aaron M. Cohen, Westford, MA (US); Peter C. Yim, Raleigh, NC (US)

(21) Appl. No.: 15/361,447

(22) Filed: Nov. 27, 2016

(51) Int. Cl. G06N 5/02; H04L 12/58

(52) U.S. Cl. CPC G06N 5/02; H04L 51/32

(57) ABSTRACT

An approach is provided that ingests question-answer pairs from an online discussion site into a question answering (QA) system by preprocessing the online discussion site prior to ingesting the data. The preprocessing of the online discussion site is performed by identifying stale questions posted to the online discussion site, analyzing the stale question to determine an appropriate trigger post, with the trigger post is designed to instigate an answer to the stale question, with the system automatically generating and posting the trigger post to the online discussion site.

### BACKGROUND OF THE INVENTION

### Description of Related Art

Forums enable communities and groups to form and work around topics (e.g., baseball, Java, hobbies, etc.), converse and ask questions. Forums have questions in various states—new, unanswered, stale. The unanswered and stale questions drive a dissatisfaction with the members, and subsequently an incomplete corpus of question-answer pairs. With the rise of cognitive solutions, forums are being coupled with cognitive agents, such that the existing knowledge of the cognitive agents are being used to automatically answer questions. With cognitive agents, there still exists unanswered or stale questions which drive dissatisfaction with the community—poor wording, uninteresting, poor visibility (tags).

### SUMMARY

An approach is provided that ingests question-answer pairs from an online discussion site into a question answering (QA) system by preprocessing the online discussion site prior to ingesting the data. The preprocessing of the online discussion site is performed by identifying stale questions posted to the online discussion site, analyzing the stale question to determine an appropriate trigger post, with the trigger post is designed to instigate an answer to the stale question, with the system automatically generating and posting the trigger post to the online discussion site.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 depicts a network environment that includes a knowledge manager that utilizes a knowledge base;

FIG. 2 is a block diagram of a processor and components of an information handling system such as those shown in FIG. 1;

FIG. 3 is a component diagram that depicts overall processes used to enhance the time-to-answer for community question and answer systems;

FIG. 4 is a depiction of a flowchart showing the logic used to analyze forum history data;

FIG. 5 is a depiction of a flowchart showing the logic used to identify stale questions that require a response and analyze question data;

FIG. 6 is a depiction of a flowchart showing the logic used to identify trigger posts in a forum;

FIG. 7 is a depiction of a flowchart showing the logic used to identify the best trigger post to use for a particular question in a particular forum; and

FIG. 8 is a depiction of a flowchart showing the logic used to generate trigger posts to stale questions designed to elicit answers from forum community.

### DETAILED DESCRIPTION

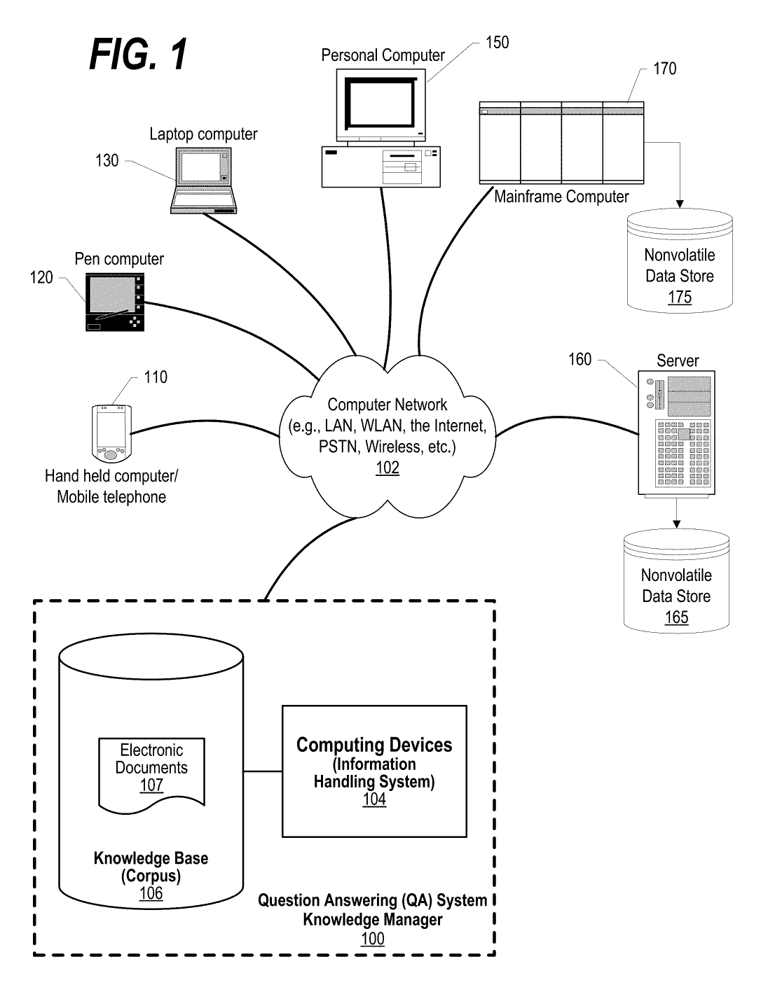

FIGS. 1-8 describe an approach that enhances the time-to-answer for community questions in online discussion site by automatically detecting a community question needs an answer, analyzing the question for provoking trigger posts, determining the best trigger post to use for the question, and provoking the community to answer the question by automatically generating the best trigger post to the online discussion site. The approach provides various advantages over traditional approaches by leveraging the common language of the community found in the online discussion site, reducing the number of unanswered questions in the online discussion site so that more question-answer pairs can be ingested in a question-answer (QA) system, and increasing the satisfaction of the online discussion site amongst the site's users.

For example, in an online discussion site suppose a user posts a question such as “What is a widget?” The approach detects that the question is unanswered after a period of time, such as two weeks. The approach then analyzes the question—“What is a widget?” The approach then determines the question for provoking possible trigger posts, and, for example, might determine that the best trigger post for the question is simply “anyone know this answer?” The approach then instigates the users of the online discussion site to answer the question by automatically posting the determined “best” trigger post to the online discussion. In this example, a second user would respond with an appropriate answer to the question.

In one embodiment, the approach is performed by three underlying components. The first component is a method of identifying existing trigger posts in the online discussion site. Here, the approach identifies questions that have been successfully answered in the online discussion site and analyzes them temporally to identify the following pattern: (1) first user posts a question; (2) an average time to answer the question elapses; (3) a second user posts a comment to provoke (trigger) the community to answer the question, and (4) another user posts an acceptable answer to the question in response to the trigger being posted. At that point the method will capture the original question and the comment which provoked the answer.

The second component is a classifier that pairs a question and the trigger post and includes them from prior question-answer pairs. In one embodiment, the classifier is performed by a search engine that searches online discussion site for question and trigger posts and includes them with question-answer pairs.

The third component is an automated forum moderator. This component listens to the forum for questions that have not been answered for an exceedingly long period of time that is uncharacteristic for that forum. The question is then fed into the second component which returns provoking trigger questions that are scored with a confidence rating. The trigger question with the highest confidence rating is deemed the “best” trigger question, and this trigger question is automatically posted to the online discussion site in order to instigate an answer to the question from the community.

In some embodiments, certain expectations are utilized by the automated moderator. First, moderators can remove posts that contain improper provoking comments which will result in them not being reused by this solution as possible trigger posts. Second, moderators can address posts that are not actionable, or match, with another post so that such posts are not identified up by the mechanism described herein, or the moderator indicates that the question is not actionable or not a question through a QA forum specific feature.

Building on this approach, coaching comments can be provided to the original user. The first component #1 might include the following this pattern: first user posts a question, second user posts a comment to coach the first user, the first user posts a second question with different wording than the original question, a third user posts an answer to the re-worded question that is accepted.

The third component could include additional standard comments to post when the second component does not identify any trigger posts to an identified question. The second component could include an additional ranking/scoring technique that prioritizes the frequency of times that the provoking (trigger) comment is used or how recently it was used. In addition, the third component could ignore questions that are not flagged as questions or are flagged as not being actionable by the online discussion site moderators.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

FIG. 1 depicts a schematic diagram of one illustrative embodiment of a question/answer creation (QA) system 100 in a computer network 102. QA system 100 may include a knowledge manager computing device 104 (comprising one or more processors and one or more memories, and potentially any other computing device elements generally known in the art including buses, storage devices, communication interfaces, and the like) that connects QA system 100 to the computer network 102. The network 102 may include multiple computing devices 104 in communication with each other and with other devices or components via one or more wired and/or wireless data communication links, where each communication link may comprise one or more of wires, routers, switches, transmitters, receivers, or the like. QA system 100 and network 102 may enable question/answer (QA) generation functionality for one or more content users. Other embodiments of QA system 100 may be used with components, systems, sub-systems, and/or devices other than those that are depicted herein.

QA system 100 may be configured to receive inputs from various sources. For example, QA system 100 may receive input from the network 102, a corpus of electronic documents 107 or other data, a content creator, content users, and other possible sources of input. In one embodiment, some or all of the inputs to QA system 100 may be routed through the network 102. The various computing devices on the network 102 may include access points for content creators and content users. Some of the computing devices may include devices for a database storing the corpus of data. The network 102 may include local network connections and remote connections in various embodiments, such that knowledge manager 100 may operate in environments of any size, including local and global, e.g., the Internet. Additionally, knowledge manager 100 serves as a front-end system that can make available a variety of knowledge extracted from or represented in documents, network-accessible sources and/or structured data sources. In this manner, some processes populate the knowledge manager with the knowledge manager also including input interfaces to receive knowledge requests and respond accordingly.

In one embodiment, the content creator creates content in electronic documents 107 for use as part of a corpus of data with QA system 100. Electronic documents 107 may include any file, text, article, or source of data for use in QA system 100. Content users may access QA system 100 via a network connection or an Internet connection to the network 102, and may input questions to QA system 100 that may be answered by the content in the corpus of data. As further described below, when a process evaluates a given section of a document for semantic content, the process can use a variety of conventions to query it from the knowledge manager. One convention is to send a well-formed question. Semantic content is content based on the relation between signifiers, such as words, phrases, signs, and symbols, and what they stand for, their denotation, or connotation. In other words, semantic content is content that interprets an expression, such as by using Natural Language (NL) Processing. Semantic data 108 is stored as part of the knowledge base 106. In one embodiment, the process sends well-formed questions (e.g., natural language questions, etc.) to the knowledge manager. QA system 100 may interpret the question and provide a response to the content user containing one or more answers to the question. In some embodiments, QA system 100 may provide a response to users in a ranked list of answers.

In some illustrative embodiments, QA system 100 may receive an input question which it then parses to extract the major features of the question, that in turn are then used to formulate queries that are applied to the corpus of data. Based on the application of the queries to the corpus of data, a set of hypotheses, or candidate answers to the input question, are generated by looking across the corpus of data for portions of the corpus of data that have some potential for containing a valuable response to the input question.

The QA system then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA system. The statistical model may then be used to summarize a level of confidence that the QA system has regarding the evidence that the potential response, i.e. candidate answer, is inferred by the question. This process may be repeated for each of the candidate answers until the QA system identifies candidate answers that surface as being significantly stronger than others and thus, generates a final answer, or ranked set of answers, for the input question.

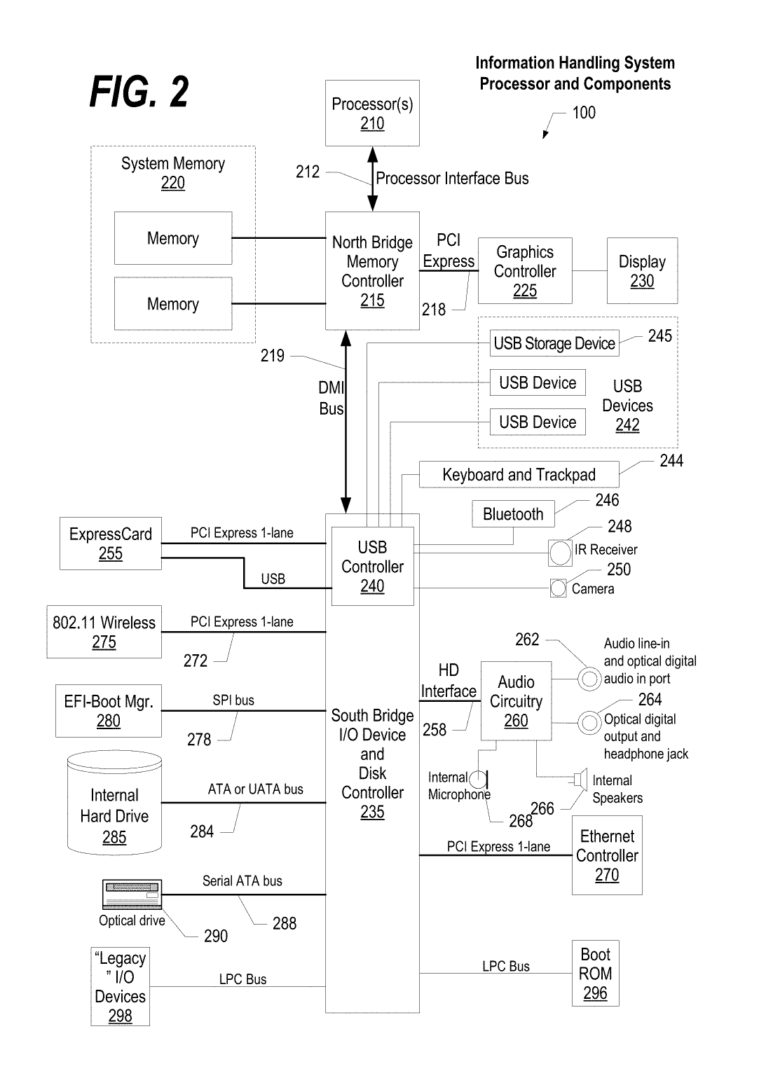

Types of information handling systems that can utilize QA system 100 range from small handheld devices, such as handheld computer/mobile telephone 110 to large mainframe systems, such as mainframe computer 170. Examples of handheld computer 110 include personal digital assistants (PDAs), personal entertainment devices, such as MP3 players, portable televisions, and compact disc players. Other examples of information handling systems include pen, or tablet, computer 120, laptop, or notebook, computer 130, personal computer system 150, and server 160. As shown, the various information handling systems can be networked together using computer network 102. Types of computer network 102 that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 1 depicts separate nonvolatile data stores (server 160 utilizes nonvolatile data store 165, and mainframe computer 170 utilizes nonvolatile data store 175. The nonvolatile data store can be a component that is external to the various information handling systems or can be internal to one of the information handling systems. An illustrative example of an information handling system showing an exemplary processor and various components commonly accessed by the processor is shown in FIG. 2.

FIG. 2 illustrates information handling system 200, more particularly, a processor and common components, which is a simplified example of a computer system capable of performing the computing operations described herein. Information handling system 200 includes one or more processors 210 coupled to processor interface bus 212. Processor interface bus 212 connects processors 210 to Northbridge 215, which is also known as the Memory Controller Hub (MCH). Northbridge 215 connects to system memory 220 and provides a means for processor(s) 210 to access the system memory. Graphics controller 225 also connects to Northbridge 215. In one embodiment, PCI Express bus 218 connects Northbridge 215 to graphics controller 225. Graphics controller 225 connects to display device 230, such as a computer monitor.

Northbridge 215 and Southbridge 235 connect to each other using bus 219. In one embodiment, the bus is a Direct Media Interface (DMI) bus that transfers data at high speeds in each direction between Northbridge 215 and Southbridge 235. In another embodiment, a Peripheral Component Interconnect (PCI) bus connects the Northbridge and the Southbridge. Southbridge 235, also known as the I/O Controller Hub (ICH) is a chip that generally implements capabilities that operate at slower speeds than the capabilities provided by the Northbridge. Southbridge 235 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 296 and “legacy” I/O devices (using a “super I/O” chip). The “legacy” I/O devices (298) can include, for example, serial and parallel ports, keyboard, mouse, and/or a floppy disk controller. The LPC bus also connects Southbridge 235 to Trusted Platform Module (TPM) 295. Other components often included in Southbridge 235 include a Direct Memory Access (DMA) controller, a Programmable Interrupt Controller (PIC), and a storage device controller, which connects Southbridge 235 to nonvolatile storage device 285, such as a hard disk drive, using bus 284.

ExpressCard 255 is a slot that connects hot-pluggable devices to the information handling system. ExpressCard 255 supports both PCI Express and USB connectivity as it connects to Southbridge 235 using both the Universal Serial Bus (USB) the PCI Express bus. Southbridge 235 includes USB Controller 240 that provides USB connectivity to devices that connect to the USB. These devices include webcam (camera) 250, infrared (IR) receiver 248, keyboard and trackpad 244, and Bluetooth device 246, which provides for wireless personal area networks (PANs). USB Controller 240 also provides USB connectivity to other miscellaneous USB connected devices 242, such as a mouse, removable nonvolatile storage device 245, modems, network cards, ISDN connectors, fax, printers, USB hubs, and many other types of USB connected devices. While removable nonvolatile storage device 245 is shown as a USB-connected device, removable nonvolatile storage device 245 could be connected using a different interface, such as a Firewire interface, etcetera.

Wireless Local Area Network (LAN) device 275 connects to Southbridge 235 via the PCI or PCI Express bus 272. LAN device 275 typically implements one of the IEEE 802.11 standards of over-the-air modulation techniques that all use the same protocol to wireless communicate between information handling system 200 and another computer system or device. Optical storage device 290 connects to Southbridge 235 using Serial ATA (SATA) bus 288. Serial ATA adapters and devices communicate over a high-speed serial link. The Serial ATA bus also connects Southbridge 235 to other forms of storage devices, such as hard disk drives. Audio circuitry 260, such as a sound card, connects to Southbridge 235 via bus 258. Audio circuitry 260 also provides functionality such as audio line-in and optical digital audio in port 262, optical digital output and headphone jack 264, internal speakers 266, and internal microphone 268. Ethernet controller 270 connects to Southbridge 235 using a bus, such as the PCI or PCI Express bus. Ethernet controller 270 connects information handling system 200 to a computer network, such as a Local Area Network (LAN), the Internet, and other public and private computer networks.

While FIG. 2 shows one information handling system, an information handling system may take many forms, some of which are shown in FIG. 1. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

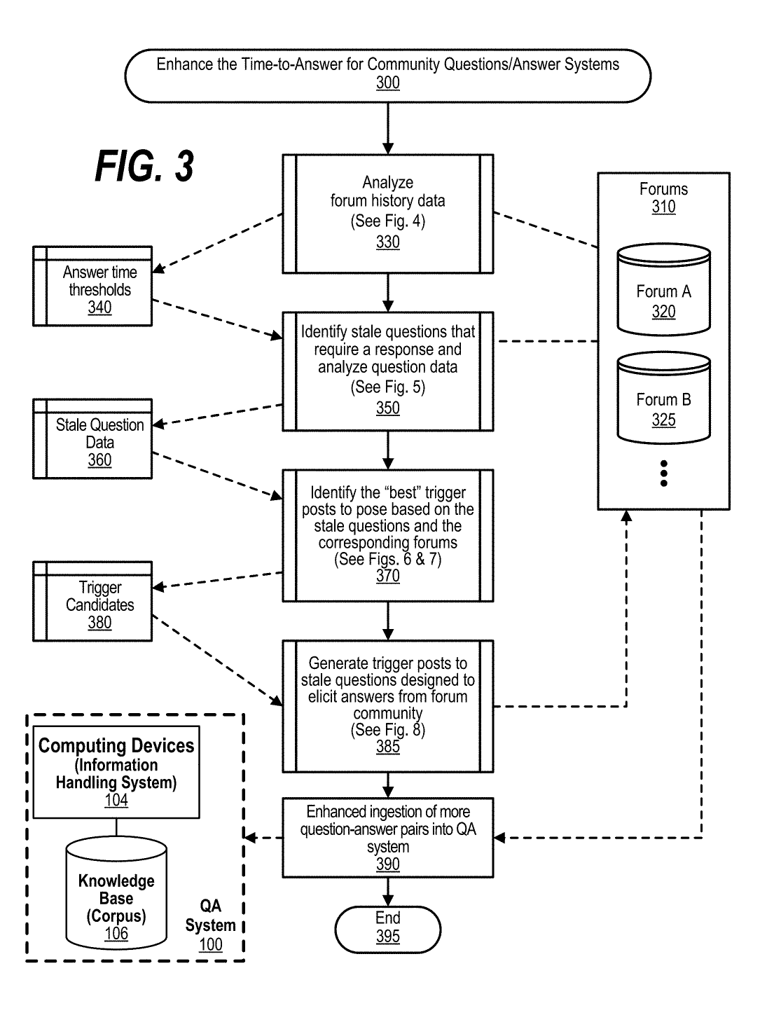

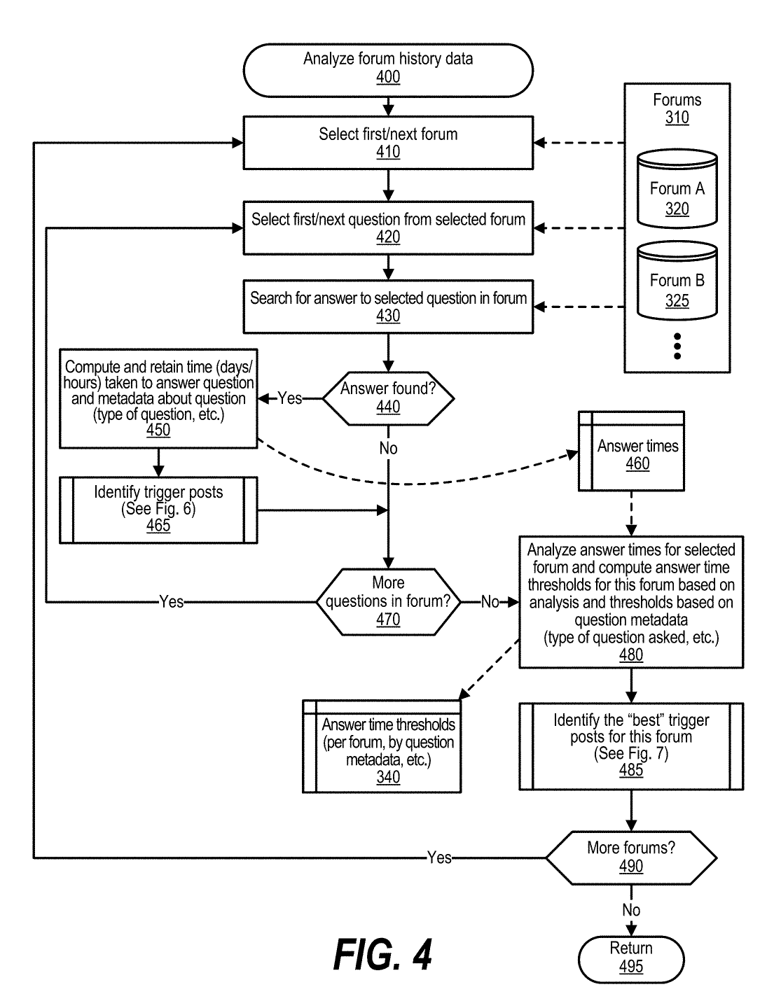

FIG. 3 is a component diagram that depicts overall processes used to enhance the time-to-answer for community question and answer systems. FIG. 3 processing commences at 300 and shows the steps taken by a process that enhances the time-to-answer for community questions/answer systems. At predefined process 330, the process performs the analyze forum history data routine (see FIG. 4 and corresponding text for processing details). This routine analyzes online discussion sites 310 that may include multiple individual forums, such as forum A (320) and forum B (325). In addition, when being used to enhance the ingestion of forum-based question-answer data into a question answering (QA) system, the analysis can also identify which forums have substantial unanswered questions that should be processed before those forums that have fewer unanswered questions. The results from predefined process 330 are stored in memory area 340 that includes the answer time thresholds and elapsed time metrics corresponding to the analyzed online discussion site.

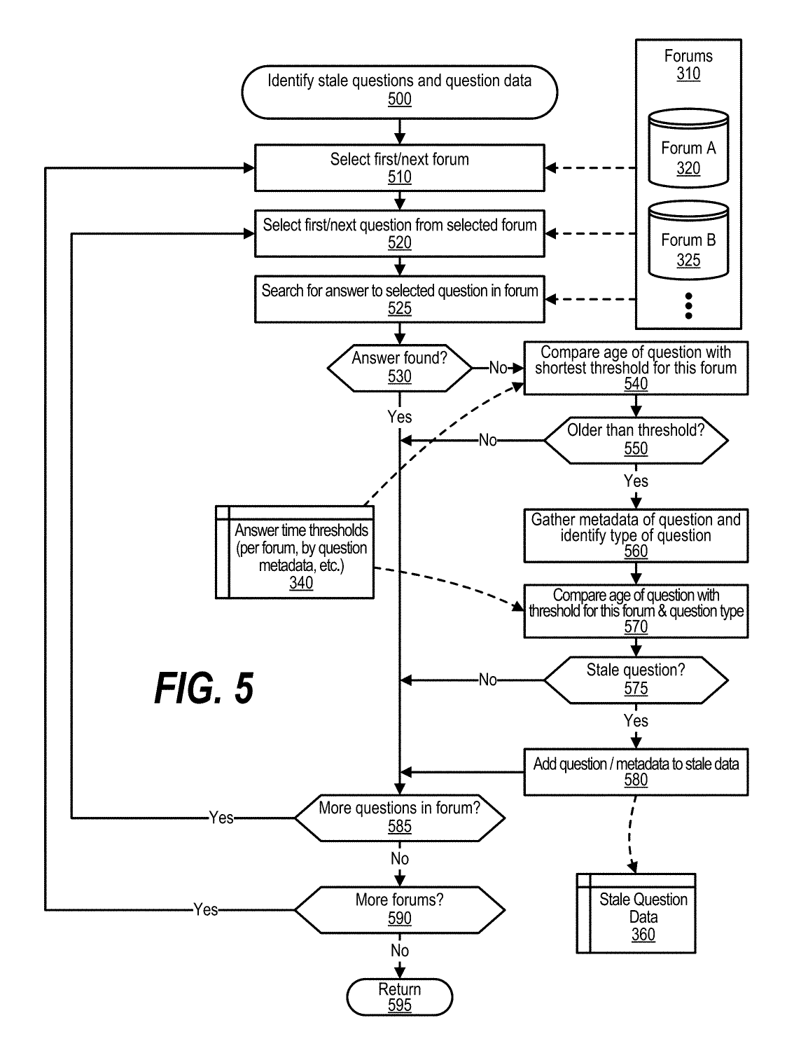

At predefined process 350, the process performs the identify stale questions that require a response and analyze question data routine (see FIG. 5 and corresponding text for processing details). This routine uses the elapsed time metrics identified by predefined process 330 and compares unanswered questions from the online discussion site to identify stale question data that is stored in memory area 360.

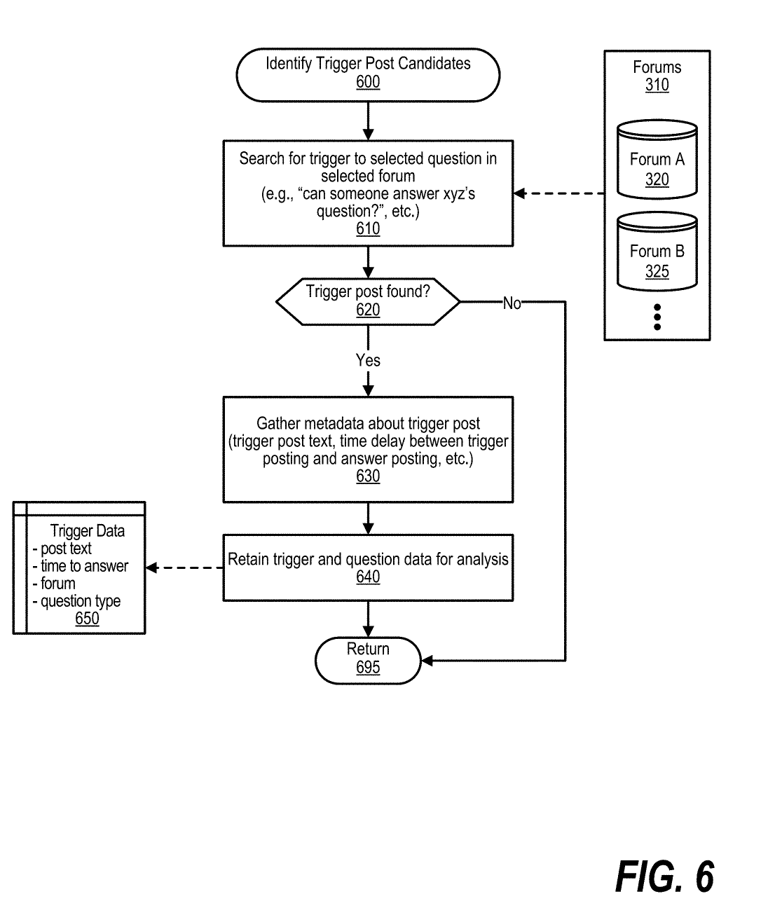

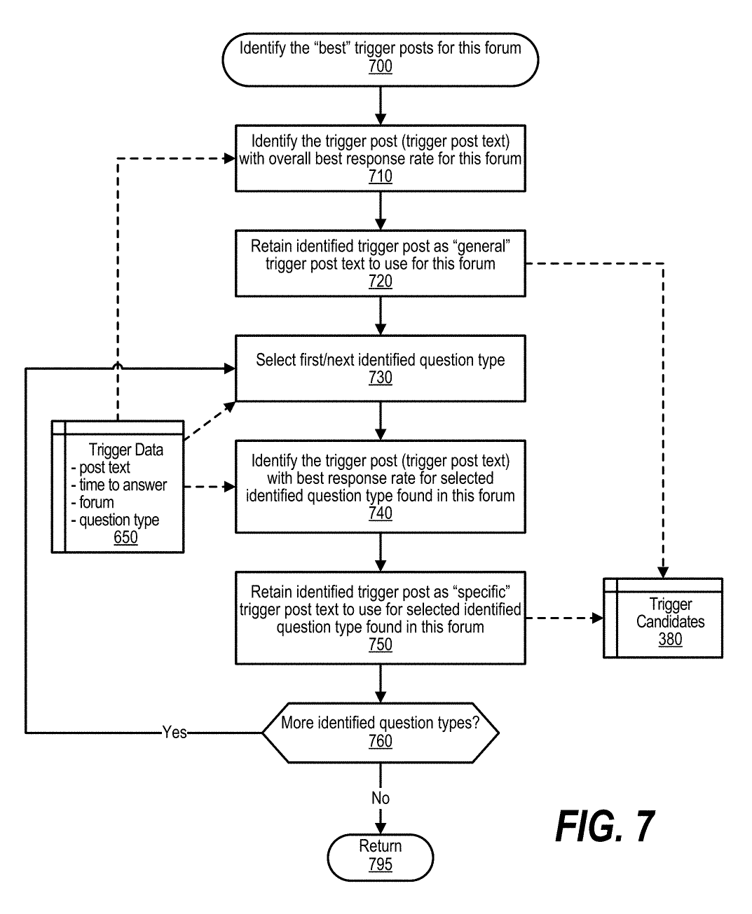

At predefined process 370, the process performs the routine (see FIGS. 6 and 7 and corresponding text for processing details). These routines identifies trigger post candidates based on an analysis of the stale questions and previously posted trigger posts. From the set of trigger post candidates, these routines also identify which particular trigger post candidate is the best trigger post candidate to use to instigate an answer from the community for the stale question. This routine retrieves the stale question data for analysis from memory area 360 and stores the trigger post candidates in memory area 380.

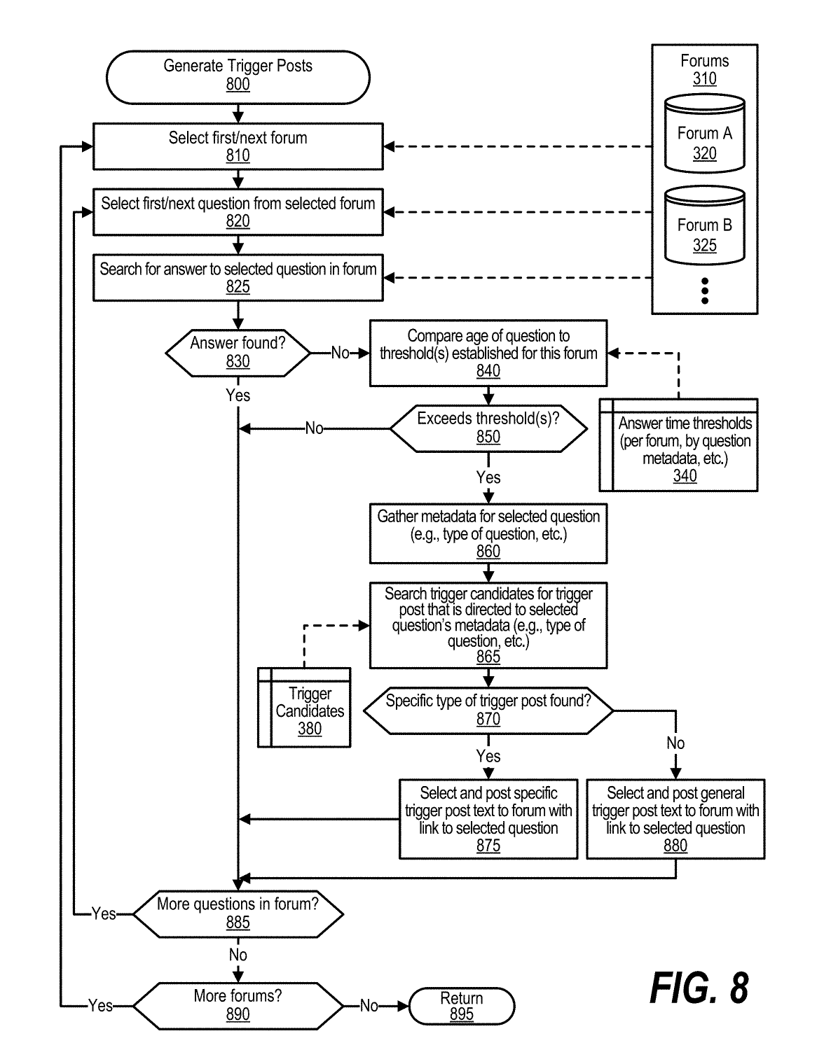

At predefined process 385, the process performs the generate trigger posts to stale questions designed to elicit answers from forum community routine (see FIG. 8 and corresponding text for processing details). This routine actually posts the identified “best” trigger post to the online discussion site in order to instigate an answer to the identified stale question from the community. The routine retrieves the trigger post from memory area 380 and posts the trigger post to the applicable forum in online discussion site 310. At step 390, the process performs an enhanced ingestion of more question-answer pairs into question answer (QA) system 100. More question-answer pairs are able to be ingested because the automatic posting of trigger posts instigated community members to answer more stale, unanswered questions, making the online discussion site a richer repository for question-answer pairs that are ingested to QA system 100. FIG. 3 processing thereafter ends at 395.

FIG. 4 is a depiction of a flowchart showing the logic used to analyze forum history data. FIG. 4 processing commences at 400 and shows the steps taken by a process that analyze forum history data. At step 410, the process selects the first forum from online discussion site 310. At step 420, the process selects the first question from the selected online discussion site. At step 430, the process searches for an answer to selected question in forum.

The process determines as to whether an answer was found to the selected question (decision 440). If an answer was found to the selected question, then decision 440 branches to the ‘yes’ branch to perform steps 450 and 465. On the other hand, if an answer was not found to the selected question, then decision 440 branches to the ‘no’ branch bypassing step 450 and 465. At step 450, the process computes and retains the elapsed time (e.g., in days, hours, etc.) that was taken to from the time the question was posted to the time that the answer to the question was posted. The elapsed time and metadata about the question (e.g., the type of question, etc.) are stored in memory area 460. At predefined process 465, the process performs the identify trigger posts routine (see FIG. 6 and corresponding text for processing details). This routine identifies any trigger posts that may have been used to provoke the community to answer the selected question in the online discussion site.

The process determines as to whether there are more questions in the online discussion site to process (decision 470). If there are more questions in the online discussion site to process, then decision 470 branches to the ‘yes’ branch which loops back to step 420 to select and process the next question from the selected forum in the online discussion site as described above. This looping continues until there are no more questions in the selected forum to process, at which point decision 470 branches to the ‘no’ branch exiting the loop.

At step 480, the process analyzes the answer times for the selected forum and computes answer time thresholds that are to be used for this forum to determine when a question is stale. This analysis and identified thresholds may also be based on question metadata (e.g., type of question asked, etc.). The answer time thresholds and corresponding question metadata are stored in memory area 340. At predefined process 485, the process performs a routine to identify the “best” trigger post for this forum (see FIG. 7 and corresponding text for processing details). These “best” trigger posts will be used to generate an automatic trigger post to the online discussion site in order to instigate an answer from the community.

The process determines as to whether there are more forums in the online discussion site to process (decision 490). If there are more forums in the online discussion site to process, then decision 490 branches to the ‘yes’ branch which loops back to step 410 to select and process the next forum as described above. This looping continues until all of the forums in the online discussion site have been processed, at which point decision 490 branches to the ‘no’ branch exiting the loop. FIG. 4 processing thereafter returns to the calling routine (see FIG. 3) at 495.

FIG. 5 is a depiction of a flowchart showing the logic used to identify stale questions that require a response and analyze question data. FIG. 5 processing commences at 500 and shows the steps taken by a process that identifies stale questions and question data. At step 510, the process selects the first forum from online discussion site 310. At step 520, the process selects the first question from the selected forum. At step 525, the process searches for an answer to the selected question in the selected forum. The process determines as to whether an answer to the selected question was found (decision 530). If an answer to the selected question was found, then decision 530 branches to the ‘yes’ branch to perform steps 540 through 580. On the other hand, if not answer found, then decision 530 branches to the ‘no’ branch bypassing steps 540 through 580.

Steps 540 through 580 are taken when an answer to the selected question is not found in the forum. At step 540, the process compares age of question with shortest threshold for this forum. The process determines as to whether the selected question is older than a predetermined threshold (decision 550). If the selected question is older than the threshold, then decision 550 branches to the ‘yes’ branch to perform steps 560 through 580. On the other hand, if the selected question is not older than the threshold, then decision 550 branches to the ‘no’ branch bypassing steps 560 through 580.

At step 560, the process gathers metadata pertaining to the selected question with the metadata identifying the type of question that was being asked (e.g., opinion related question, experience related question, factual question, etc.). At step 570, the process compares the age of the selected question with a threshold set for this forum and this question type (e.g., one week for this forum with the question being a factual-based question, two weeks when the question is an experienced based question, etc.).

The process determines as to whether, based on the comparison, the selected question is a stale question (decision 575). If the selected question is a stale question, then decision 575 branches to the ‘yes’ branch to perform step 580. On the other hand, if the selected question is not a stale question, then decision 575 branches to the ‘no’ branch bypassing step 580. At step 580, the process adds the selected question and the metadata gathered for the selected question to a set of stale question data that is stored in memory area 360.

The process determines as to whether there are more questions in the selected forum to process (decision 585). If there are more questions in the selected forum to process, then decision 585 branches to the ‘yes’ branch which loops back to step 520 to select and process the next question from the selected forum as described above. This looping continues until all of the questions in the selected forum have been processed, at which point decision 585 branches to the ‘no’ branch exiting the loop.

The process determines as to whether more forums in online discussion site 310 to process (decision 590). If more forums in online discussion site 310 to process, then decision 590 branches to the ‘yes’ branch which loops back to step 510 to select and process the next forum from the online discussion site as described above. This looping continues until all of the forums in the online discussion site have been processed, at which point decision 590 branches to the ‘no’ branch exiting the loop. FIG. 5 processing thereafter returns to the calling routine (see FIG. 3) at 595.

FIG. 6 is a depiction of a flowchart showing the logic used to identify trigger posts in a forum. FIG. 6 processing commences at 600 and shows the steps taken by a process that identifies trigger post candidates found in online discussion site 310. At step 610, the process searches for triggers to a selected question in the selected forum of the online discussion site. For example, a trigger post to a first user's question might be, “can someone answer xyz's question?”

The process determines as to whether a trigger post was found for the selected question (decision 620). If a trigger post was found for the selected question, then decision 620 branches to the ‘yes’ branch to perform steps 630 and 640. On the other hand, if a trigger post was not found for the selected question, then decision 620 branches to the ‘no’ branch bypassing steps 630 and 640.

When trigger post is found for the selected question, then steps 630 and 640 are performed. At step 630, the process gathers metadata about the identified trigger post. This metadata might include the trigger post text, and the time delay between the posting of the trigger post and the posting of the question, and the time delay between the posting of the answer following the posting of the trigger post. At step 640, the process retains the trigger post data and metadata and the corresponding question data for future analysis in memory area 650. In one embodiment, the data retained includes the trigger post text, the time taken to answer the question following the posting of the trigger post, the amount of time that elapsed between the posting of the question and the posting of the trigger post, and the type of question that was asked. FIG. 6 processing thereafter returns to the calling routine (see FIG. 4) at 695.

FIG. 7 is a depiction of a flowchart showing the logic used to identify the best trigger post to use for a particular question in a particular forum. FIG. 7 processing commences at 700 and shows the steps taken by a process that identifies the “best” trigger post from a set of candidate trigger posts to use for a particular online discussion site. At step 710, the process identifies the trigger post (trigger post text) that has the best overall success rate in terms of instigating a response from members of the online discussion site in the shortest amount of time. The trigger post text and its response time metadata are retrieved from memory area 650. At step 720, the process retains the best “general” trigger post text to use for this forum to use in order to instigate a response to a general question posted to this forum. The identified “general” trigger post text and its corresponding metadata are stored in trigger candidates memory area 380.

At step 730, the process selects the first identified question type from the question types stored in memory area 650. At step 740, the process identifies the trigger post (trigger post text) with best response rate for instigating a response to questions of the selected question type found in this forum of the online discussion site. The trigger post text and its corresponding metadata are retrieved from memory area 650. At step 750, the process retains the identified trigger post as the “specific” trigger post text that should be used to instigate a response to an unanswered question of the selected question type that has been posted to this forum of the online discussion site. The identified “specific” trigger post text and its corresponding metadata are stored in trigger candidates memory area 380.

The process determines as to whether there are more identified question types to select and process as described above (decision 760). If there are more identified question types to select and process, then decision 760 branches to the ‘yes’ branch which loops back to step 730 to select and process the next identified question type as described above. This looping continues until all of the identified question types have been processed, at which point decision 760 branches to the ‘no’ branch exiting the loop. FIG. 7 processing thereafter returns to the calling routine (see FIG. 4) at 795.

FIG. 8 is a depiction of a flowchart showing the logic used to generate trigger posts to stale questions designed to elicit answers from forum community. FIG. 8 processing commences at 800 and shows the steps taken by a process that automatically generates and posts trigger posts to an online discussion site. At step 810, the process selects the first forum from the online discussion site 310. At step 820, the process selects the first question from the selected forum. At step 825, the process searches the selected forum for an answer to the selected question.

The process determines as to whether the selected question has been answered in the selected forum (decision 830). If the selected question has been answered, then decision 830 branches to the ‘yes’ branch bypassing steps 840 through 880. On the other hand, if the selected question has not yet been answered, then decision 830 branches to the ‘no’ branch for further processing performed by steps 840 through 880.

At step 840, the process compares the elapsed time from the posting of the question (the age of the question) to a time-based threshold established for this forum. The process next determines whether the age of the question exceeds the established threshold for this forum (decision 850). If the age of the question exceeds the established threshold, indicating that the question is stale, then decision 850 branches to the ‘yes’ branch to perform steps 860 through 880. On the other hand, if the age of the question does not exceed the established threshold, indicating that the question is not yet stale, then decision 850 branches to the ‘no’ branch bypassing steps 860 through 880.

At step 860, the process gathers metadata pertaining to the selected question, with such metadata including the type of question that is being asked in the selected question. At step 865, the process searches trigger candidates from memory area 38 for a trigger post that is directed to the selected question's metadata (e.g., type of question, etc.). The process determines as to whether a specific type of trigger post found was found for the selected question (decision 870). If a specific type of trigger post found was found, then decision 870 branches to the ‘yes’ branch whereupon, at step 875, the process selects and posts specific trigger post text that was retrieved from memory area 380 to the selected forum. On the other hand, if a specific type of trigger post found was not found, then decision 870 branches to the ‘no’ branch whereupon, at step 880, the process selects and posts general trigger post text that was retrieved from memory area 380 to the selected forum. In one embodiment, the trigger post (specific or general) that is posted to the online discussion site includes a link to the selected question.

The process determines as to whether there are more questions in the selected forum to select and process as described above (decision 885). If there are more questions in the selected forum to select and process, then decision 885 branches to the ‘yes’ branch which loops back to step 820 to select and process the next question from the selected forum. This looping continues until there are no more questions to process from the selected forum, at which point decision 885 branches to the ‘no’ branch exiting the loop.

The process determines as to whether there are more forums in the online discussion site to select and process (decision 890). If there are more forums in the online discussion site to select and process, then decision 890 branches to the ‘yes’ branch which loops back to step 810 to select and process the next forum from the online discussion site as described above. This looping continues until there are no more forums to process from the online discussion site, at which point decision 890 branches to the ‘no’ branch exiting the loop. FIG. 8 processing thereafter returns to the calling routine (see FIG. 3) at 895.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method implemented by an information handling system that includes a processor and a memory accessible by the processor, the method comprising:
ingesting question-answer pairs from an online discussion site into a question answering (QA) system by preprocessing the online discussion site prior to ingesting, wherein the preprocessing of the online discussion site further comprises:
identifying a stale question in the online discussion site, wherein an answer to the stale question is not detected as being posted to the online discussion site;
analyzing the identified stale question to determine a trigger post, wherein the trigger post is designed to instigate the answer to the stale question to be posted to the online discussion site;
automatically generating the trigger post; and
automatically posting the generated trigger post to the online discussion site.

2. The method of claim 1 wherein the preprocessing further comprises:
analyzing a plurality of previously posted trigger posts found in the online discussion site, wherein the previously posted trigger posts correspond to previously posted stale questions and responsive answers that were posted after the previously posted trigger posts, wherein the analysis determines an effectiveness of the previously posted trigger posts in instigating the responsive answers.

3. The method of claim 2 wherein the preprocessing further comprises:
identifying an elapsed time between each of the previously posted trigger posts and the corresponding responsive answers, wherein the effectiveness is based on the identified elapsed time.

4. The method of claim 2 wherein the preprocessing further comprises:
identifying a question type pertaining to each of the previously posted stale questions;
comparing the identified question types with the corresponding previously posted trigger posts; and
identifying one or more trigger post types that are effective in instigating responsive answers to the previously posted stale answers, wherein the effectiveness is based on the question type and the corresponding identified trigger post types.

5. The method of claim 4 wherein the preprocessing further comprises:
comparing a question text corresponding to the identified stale question with a plurality of question texts corresponding to the previously posted stale questions, wherein the trigger post is selected based on the comparison.

6. The method of claim 5 wherein the preprocessing further comprises:
identifying a plurality of trigger post candidates that includes the trigger post;
comparing a set of metadata corresponding to each of the trigger post candidates to a set of metadata corresponding to the identified stale question; and
selecting the trigger post from the plurality of trigger post candidates based on the comparison.

7. The method of claim 1 wherein the preprocessing further comprises:
analyzing a plurality of previously posted trigger posts found in the online discussion site, wherein the previously posted trigger posts correspond to previously posted stale questions that were posted after the previously posted trigger posts;
identifying an elapsed time metric between the previously posted trigger posts and their corresponding previously posted stale questions; and
using the elapsed time metric to determine when a question posted to the online discussion site becomes stale.

8. An information handling system comprising:
one or more processors;
a memory coupled to at least one of the processors; and
a set of computer program instructions stored in the memory and executed by at least one of the processors in order to perform actions comprising:
ingesting question-answer pairs from an online discussion site into a question answering (QA) system by preprocessing the online discussion site prior to ingesting, wherein the preprocessing of the online discussion site further comprises:
identifying a stale question in the online discussion site, wherein an answer to the stale question is not detected as being posted to the online discussion site;
analyzing the identified stale question to determine a trigger post, wherein the trigger post is designed to instigate the answer to the stale question to be posted to the online discussion site;
automatically generating the trigger post; and
automatically posting the generated trigger post to the online discussion site.

9. The information handling system of claim 8 wherein the preprocessing further comprises:
analyzing a plurality of previously posted trigger posts found in the online discussion site, wherein the previously posted trigger posts correspond to previously posted stale questions and responsive answers that were posted after the previously posted trigger posts, wherein the analysis determines an effectiveness of the previously posted trigger posts in instigating the responsive answers.

10. The information handling system of claim 9 wherein the preprocessing further comprises:
identifying an elapsed time between each of the previously posted trigger posts and the corresponding responsive answers, wherein the effectiveness is based on the identified elapsed time.

11. The information handling system of claim 9 wherein the preprocessing further comprises:
identifying a question type pertaining to each of the previously posted stale questions;
comparing the identified question types with the corresponding previously posted trigger posts; and
identifying one or more trigger post types that are effective in instigating responsive answers to the previously posted stale answers, wherein the effectiveness is based on the question type and the corresponding identified trigger post types.

12. The information handling system of claim 11 wherein the preprocessing further comprises:
comparing a question text corresponding to the identified stale question with a plurality of question texts corresponding to the previously posted stale questions, wherein the trigger post is selected based on the comparison.

13. The information handling system of claim 12 wherein the preprocessing further comprises:
identifying a plurality of trigger post candidates that includes the trigger post;
comparing a set of metadata corresponding to each of the trigger post candidates to a set of metadata corresponding to the identified stale question; and
selecting the trigger post from the plurality of trigger post candidates based on the comparison.

14. The information handling system of claim 8 wherein the preprocessing further comprises:
analyzing a plurality of previously posted trigger posts found in the online discussion site, wherein the previously posted trigger posts correspond to previously posted stale questions that were posted after the previously posted trigger posts;
identifying an elapsed time metric between the previously posted trigger posts and their corresponding previously posted stale questions; and
using the elapsed time metric to determine when a question posted to the online discussion site becomes stale.

15. A computer program product stored in a computer readable storage medium, comprising computer program code that, when executed by an information handling system, performs actions comprising:
ingesting question-answer pairs from an online discussion site into a question answering (QA) system by preprocessing the online discussion site prior to ingesting, wherein the preprocessing of the online discussion site further comprises:
identifying a stale question in the online discussion site, wherein an answer to the stale question is not detected as being posted to the online discussion site;
analyzing the identified stale question to determine a trigger post, wherein the trigger post is designed to instigate the answer to the stale question to be posted to the online discussion site;
automatically generating the trigger post; and
automatically posting the generated trigger post to the online discussion site.

16. The computer program product of claim 15 wherein the preprocessing further comprises:
analyzing a plurality of previously posted trigger posts found in the online discussion site, wherein the previously posted trigger posts correspond to previously posted stale questions and responsive answers that were posted after the previously posted trigger posts, wherein the analysis determines an effectiveness of the previously posted trigger posts in instigating the responsive answers.

17. The computer program product of claim 16 wherein the preprocessing further comprises:
identifying an elapsed time between each of the previously posted trigger posts and the corresponding responsive answers, wherein the effectiveness is based on the identified elapsed time.

18. The computer program product of claim 16 wherein the preprocessing further comprises:
identifying a question type pertaining to each of the previously posted stale questions;
comparing the identified question types with the corresponding previously posted trigger posts; and
identifying one or more trigger post types that are effective in instigating responsive answers to the previously posted stale answers, wherein the effectiveness is based on the question type and the corresponding identified trigger post types.

19. The computer program product of claim 18 wherein the preprocessing further comprises:
comparing a question text corresponding to the identified stale question with a plurality of question texts corresponding to the previously posted stale questions, wherein the trigger post is selected based on the comparison.

20. The computer program product of claim 19 wherein the preprocessing further comprises:
identifying a plurality of trigger post candidates that includes the trigger post;
comparing a set of metadata corresponding to each of the trigger post candidates to a set of metadata corresponding to the identified stale question; and
selecting the trigger post from the plurality of trigger post candidates based on the comparison.
